(19) United States
(12) Patent Application Publication
(10) Pub. No.: US 2012/0069814 A1
(43) Pub. Date: Mar. 22, 2012

(54) Frequency Allocation Device and Program Therefor

(76) Inventors: Satoshi Konishi, Fujimino-shi (JP); Takeo Ohseki, Fujimino-shi (JP)

(21) Appl. No.: 13/322,498

(22) PCT Filed: May 26, 2010
(86) PCT No.: PCT/JP2010/003533

§ 371 Date: Nov. 25, 2011

(30) Foreign Application Priority Data
May 27, 2009 (JP) 2009-127644

(51) Int. Cl. H04W 72/04

(52) U.S. Cl. 370/329

(57) ABSTRACT

A frequency allocation part (a frequency allocation device) of a base station device includes a cell-edge area unallocated channel estimation part for estimating a cell-edge area unallocated channel (or a cell-edge area unallocated RB) corresponding to a frequency channel (RB) which an adjacent base station device does not allocate to a mobile station (UE) in a cell-edge area; and a channel allocation part for allocating the cell-edge area unallocated channel, estimated by the cell-edge area unallocated channel estimation part, to a mobile station in a cell area.

### TECHNICAL FIELD

The present invention relates a frequency allocation device and a program therefor.

The present invention claims priority on Japanese Patent Application No. 2009-127644 filed May 27, 2009, the entire content of which is incorporated herein by reference.

### BACKGROUND ART

Recently, standardization organizations such as 3GPP (3rd Generation Partnership Project), 3GPP2 (3rd Generation Partnership Project 2), and IEEE802.16 have being considering standardization of subsequent systems succeeding third generation (3G) cellular systems, namely a next generation cellular system (which may be called a 3.9G cellular system) such as LTE (Long Term Evolution: its formal name is Evolved Universal Terrestrial Radio Access (E-UTRA)) and UMB (Ultra Mobile Broadband), as well as an advanced 3.9G cellular system, namely an IMT-Advanced system (which may be called a 4G cellular system).

LTE, UMB, and WiMAX systems, and LTE-Advanced and IEEE802.16m that have been developed for use in 4G cellular system adopt a multiple access method of OFDMA (Orthogonal Frequency Division Multiple Access).

Radio systems using OFDMA (hereinafter, referred to as “OFDMA system”) are able to allocate subcarriers, within a certain frequency range, to a plurality of mobile stations (user terminals). The OFDMA system is able to change mobile stations allocated to subcarriers in a time-axis direction. By administrating radio resources two-dimensionally in a frequency axis and a time axis, the OFDMA system can implement flexible allocation of radio resources.

In general, cellular systems reuse the same frequency band with a plurality of cells (hereinafter, “cells” may contain “sectors”) to improve a frequency utilization efficiency. The method for reusing the whole frequency band, available in a cellular system, is called “1-cell repetition”. The 3G cellular system adopting CDMA (Code Division Multiple Access) is able to separate communication channels using codes even when adjacent cells share the same frequency band. In FDMA or OFDMA, however, adjacent cells sharing the same frequency band will degrade a communication quality due to interference. In particular, mobile stations in cell-edge areas undergo long transmission distances with a base station so that their signal power levels are low while adjacent cells increase interference power levels, so that their communication quality tends to be degraded, thus causing a reduction of throughput.

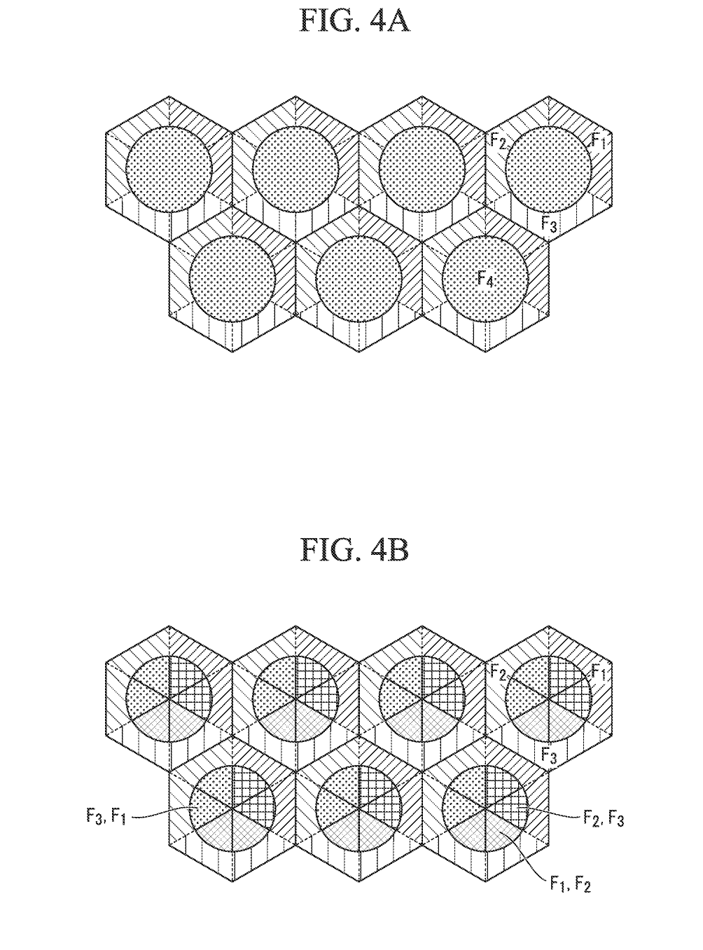

To prevent the above problem, for example, a technology called fractional frequency reuse (FFR) has been developed (see Non-Patent Documents 1 to 4). This separates a frequency band for use in a cell-edge area and a frequency band for use in a cell-central area, wherein another frequency reuse technology called “3-cell repetition” is adopted in the frequency band for the cell-edge area. FIGS. 4A and 4B show examples of FFR. In the examples of FFR shown in FIGS. 4A and 4B, frequency bands F1, F2, and F3, which differ from each other (or which are perpendicular to each other) on the frequency axis, are allocated to the cell-edge area of each sector, whilst the common frequency band is allocated to the cell-central area. In the example shown in FIG. 4A, for example, a frequency band F4, which differs from the frequency bands F1, F2, and F3, is allocated to the cell-central area. In this example, the cell-edge area undergoes “3-cell repetition” whilst the cell-central area undergoes “1-cell repetition”. In the example shown in FIG. 4B, the frequency bands F1, F2, and F3, which have been allocated to the cell-edge area, are reused for (or allocated to) the cell-central area, whereas the frequency band, which differs from the frequency band allocated to the cell-edge area, is allocated to the cell-central area with respect to each cell. For instance, the frequency bands F2 and F3, which differ from the frequency band F1, are allocated to the cell-central area in the sector in which the frequency band F1 is allocated to the cell-edge area.

Concrete examples for adapting the FFR technology to the IEEE802.16e system has been developed as well (see, Patent Document 1). The IEEE802.16e system may adopt a sub-channel configuration method (i.e. a correspondence relationship between sub-channels and subcarriers) called IDcell. The IEEE802.16e sets IDcell per each cell. With the same IDcell indicating the same sub-channel configuration method, radio resources that are made by further dividing sub-channels in the frequency-axis direction or the time-axis direction must be perpendicular to each other. With different values of IDcell indicating different sub-channel configuration methods, radio resources may not be completely perpendicular to each other. Patent Document 1 provides a technology in which radio resources perpendicular to each other are applied to the cell-edge area while radio resources that are not completely perpendicular to each other but semi-perpendicular to each other are applied to the cell-central area.

As described above, the FFR technology disclosed in Non-Patent Documents 1 to 4 and Patent Document 1 are designed such that the frequency channel, other than frequency channels allocated to cell-edge areas of adjacent cells, is allocated to the cell-edge area of one cell. This provides an effect of reducing interference.

Non-Patent Document 5 defines control information which is deemed applicable to the FFR technology. For instance, it defines control information relating to the interstation interface of the LTE system by way of (1) and (2) described below. In this connection, Patent Document 2 employs information called OI (discussed later) representing the magnitude of interference among various pieces of control information defined in Non-Patent Document 5, thus providing a power control method adapted to an uplink (UL) reference signal and a control channel.

(1) Downlink (DL)-related control information RNTP (Relative Narrowband Tx Power): A binary value representing the magnitude of available transmission power. This is notified to adjacent cells. For instance, RNTP is set to “1” when transmission power per each RB exceeds a threshold value, whilst RNTP is set to “0” when transmission power per each RB is lower than the threshold value (see Non-Patent Document 5).

(2) Uplink (UL)-Related Control Information

(2)-1. HII (High Interface Indication): A binary value representing existence/nonexistence of interference. This is notified to adjacent cells. For instance, HII is set to “1” when each RB undergoes a high interference, whilst HII is set to “0” when no interference occurs (see Non-Patent Document 5).

(2)-2. OI (Overload Indication): The information called “high interference, medium interference, low interference” is notified to adjacent cells per each RB.

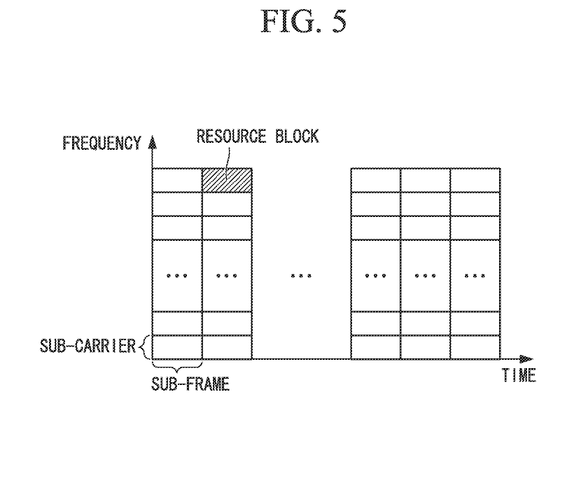

FIG. 5 shows a concept of radio resources in the OFDMA system. Non-Patent Document 6 refers to resource blocks (RB) each defined with one subcarrier having a bandwidth of 180 kHz and one sub-frame having one millisecond. Non-Patent Document 6 utilizes twelve subcarriers. According to Non-Patent Document 6, a base station of the cellar system determines each mobile station, allocated with each RB, (corresponding to UE (User Equipment) in the terminology of Non-Patent Document 6).

### PRIOR ART DOCUMENT

### Patent Document

Patent Document 1: Japanese Patent Application Publication No. 2008-167413

Patent Document 2: Japanese Patent Application Publication No. 2008-193439

### Non-Patent Document

Non-Patent Document 1: Konishi et al, “A Study on Fractional Frequency Reuse for OFDMA Cellular System”, 2007 Singaku Society Convention, B-5-59, September 2007
Non-Patent Document 2: Fujii et al, “Characteristic Analysis of OFDMA Cellular System Using Fractional Frequency Reuse”, Singaku Giho RCS2007-161, January 2008
Non-Patent Document 3: Seung Su Han et al, “A New Frequency Partitioning and Allocation of Subcarriers for Fractional Frequency Reuse in Mobile Communication Systems” IEICE Trans. Commun., Vol. E91-B, No. 8, pp. 2748-2751, August 2008
Non-Patent Document 4: Komine et al, “Characteristic Evaluation on Fractional Frequency Reuse in Evolved UTRA”, 2008 Singaku Society Convention, BS-4-9, September 2008
Non-Patent Document 5: 3GPP TS 36.423, “Evolved Universal Terrestrial Radio Access Network (E-UTRAN), X2 Application Protocol (X2AP)”
Non-Patent Document 6: 3GPP TS 36.211, “Evolved Universal Terrestrial Radio Access (E-UTRA); Physical Channels and Modulation (Release 8)”
Non-Patent Document 7: 3GPP TS 36.214, “Evolved Universal Terrestrial Radio Access (E-UTRA); Physical Layer-Measurements (Release 8)”

### SUMMARY OF THE INVENTION

### Problem to be Solved by the Invention

The conventional FFR technology disclosed in Non-Patent Documents 1 to 4 and Patent Document 1 presupposes static FFR (i.e. FFR as shown in FIGS. 4A and 4B with the fixed (uniform) cell shape (cell configuration), the fixed (regular) cell alignment, and the fixed boundary between the cell-central area and the cell-edge area commonly employed among all cells) based on a static environment undergoing uniform traffic secured with respect to all areas subjected to evaluation. However, the real environment may undergo dispersions of traffic and dynamic fluctuations of actual cell shapes and cell alignment. For instance, cell shapes may fluctuate depending on the employed antenna directivity, the antenna tilt-angle, and radio wave propagation environments, while cell alignment may fluctuate due to installation of new cells or abandonment of cells. Therefore, even when the conventional FFR technology presupposing the static FFR is applied to the real environment, it is difficult to obtain an effect of reducing interference. Additionally, concrete methods for using control information of interstation interfaces and thus realizing dynamic FFR adapted to the real environment depend on the installation manner are not disclosed in Non-Patent Document 5. No method implementing dynamic FFR using control information of interstation interfaces has been developed yet.

The present invention is made in consideration of the foregoing problem, wherein the object thereof is to provide a technology for reducing interference with dynamic FFR adapted to the real environment.

### Means for Solving the Problem

To solve the above problem, a frequency allocation device according to one embodiment of the present invention, serving as a frequency allocation device for allocating a frequency channel, used for communication, to a mobile station located in an area of a first cell, includes a cell-edge area unallocated channel estimation unit for estimating a cell-edge area unallocated channel, which is a frequency channel other than a frequency channel that an adjacent frequency allocation device located in a second cell adjacent to the first cell allocates to a mobile station located in the edge area of the second cell, and a channel allocation unit for allocating the cell-edge area unallocated channel to the mobile station located in the area of the first cell. In the frequency allocation device, the channel allocation unit allocates the cell-edge area unallocated channel to all the allocation-requesting mobile stations located in the area of the first cell.

In the frequency allocation device, the channel allocation unit may allocate the cell-edge area unallocated channel to a mobile station located in the edge area of the first cell prior to a mobile station located in the central area of the first cell.

In the frequency allocation device, when the channel allocation unit cannot allocate the cell-edge area unallocated channel to all the allocation-requesting mobile stations located in the area of the first cell, it is possible to allocate the cell-edge area unallocated channel to the allocation-requesting mobile station located in the edge area of the first cell.

In the frequency allocation device, when the channel allocation unit allocates the cell-edge area unallocated channel to the mobile station, which needs allocation, located in the edge area of the first cell while allocating a frequency channel other than the cell-edge area unallocated channel to the allocation-requesting mobile station located in the central area of the first cell, it is possible to allocate a residual allocable frequency channel to a residual allocation-requesting mobile station.

In the frequency allocation device, the cell-edge area unallocated channel estimation unit receives a decision result on a decision per each frequency channel as to whether or not the adjacent frequency allocation device has allocated the frequency channel to the mobile station located in the edge area of the second cell, wherein based on the decision result, the cell-edge area unallocated channel estimation unit calculates a cell-edge area allocation likelihood representing a likelihood of each frequency channel to be allocated to each mobile station located in the edge area of the first cell, thus estimating the cell-edge area unallocated channel corresponding to a frequency channel with the cell-edge area allocation likelihood less than a threshold value.

The frequency allocation device may further include a cell-edge area allocation existence/nonexistence decision unit for determining the existence/nonexistence of each frequency channel to be allocated to the mobile station located in the edge area of the first cell based on the allocation result of the channel allocation unit, wherein the cell-edge area allocation existence/nonexistence decision unit transmits its decision result to the adjacent frequency allocation device.

To solve the above problem, a frequency allocation device according to another embodiment of the present invention is a frequency allocation device that changes a frequency channel allocated to a mobile station, remaining stationary in the area of the first cell, with respect to time, wherein a frequency channel other than a frequency channel which another frequency allocation device located in a second cell adjacent to the first cell allocates to a mobile station located in the edge area of the second cell is estimated and allocated to a mobile station located in the edge area of the first cell prior to a mobile station located in the central area of the first cell.

To solve the above problem, a program according to a further embodiment of the present invention causes a computer of a frequency allocation device, which allocates a frequency channel used for communication to a mobile station located in the area of the first cell, to implement a cell-edge area unallocated channel estimation step for estimating a cell-edge area unallocated channel corresponding to a frequency channel other than a frequency channel which an adjacent frequency allocation device located in a second cell adjacent to the first cell allocates to a mobile station located in the edge area of the second cell, and a channel allocation step for allocating the cell-edge area unallocated channel to a mobile station located in the area of the first cell.

### Effect of the Invention

The present invention involving dynamic FFR adapted to the real environment is designed to allocate a frequency channel, other than a frequency channel which has been allocated to the edge area of an adjacent cell, to the edge area of a current cell, thus reducing interference.

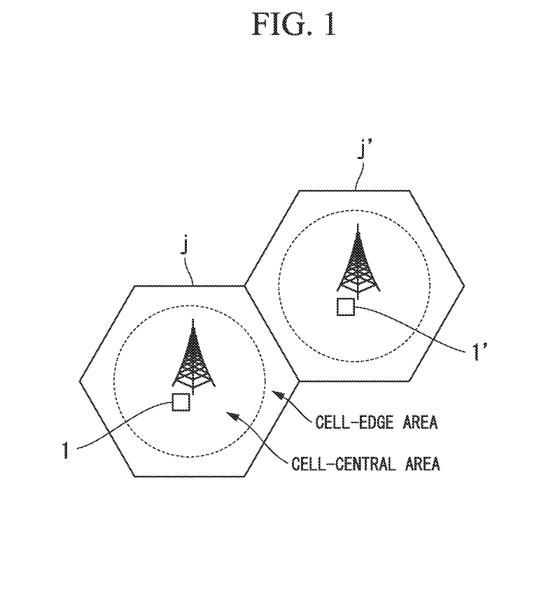

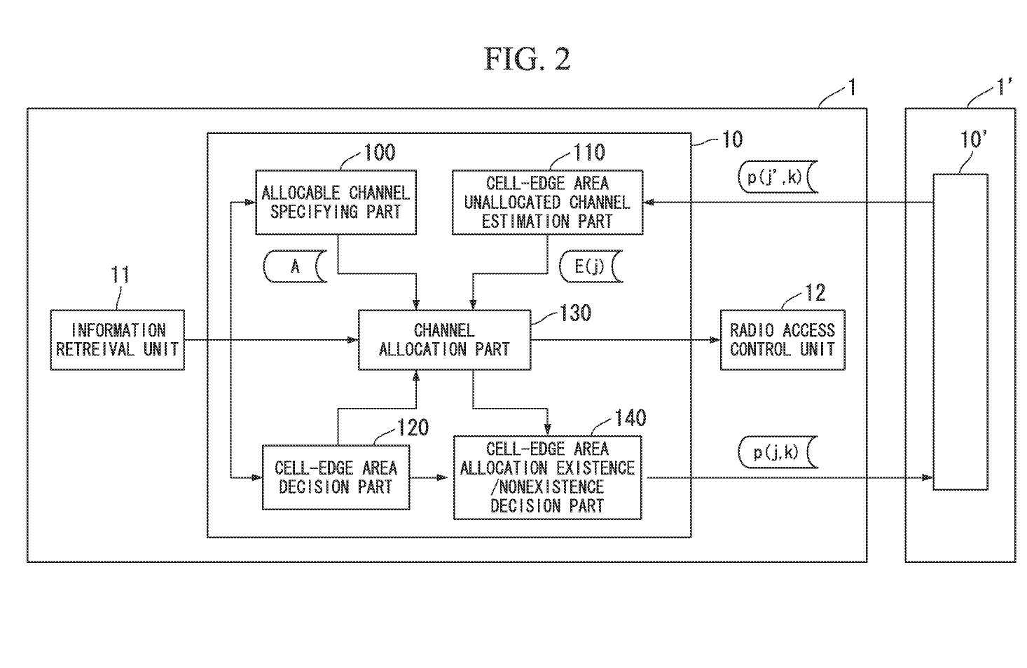

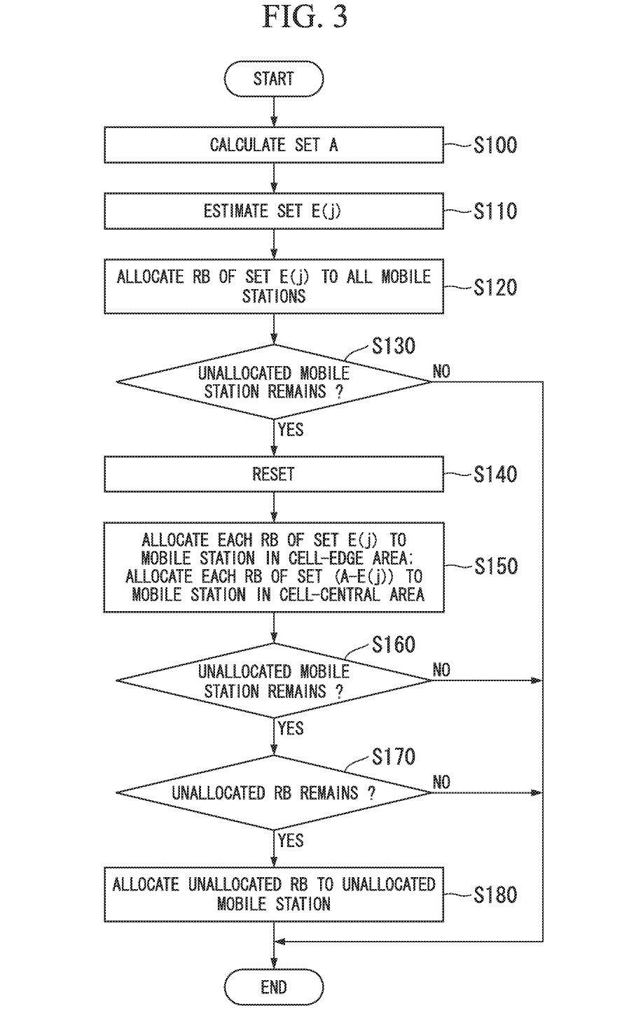

### BRIEF DESCRIPTION OF THE DRAWINGS

[FIG. 1] An illustration of a cellular system including a base station device according to one embodiment of the present invention.

[FIG. 2] A block diagram of the base station device according to one embodiment of the present invention.

[FIG. 3] A flowchart illustrating one example of operation of the base station device according to one embodiment of the present invention.

[FIG. 4A] An illustration of one example of frequency allocation adopting fractional frequency reuse according to the prior art.

[FIG. 4B] An illustration of another example of frequency allocation adopting fractional frequency reuse according to the prior art.

[FIG. 5] An illustration of resource blocks in an OFDMA system.

### MODE FOR CARRYING OUT THE INVENTION

Hereinafter, a base station device 1 according to one embodiment of the present invention will be described with reference to the drawings. As shown in FIG. 1, the base station device 1 and its adjacent base station device 1′ configure a cellular system. The base station device 1 performs communication in cell j while the base station device 1′ performs communication in cell j′. Each of the cells j and j′ is constituted of a cell-central area and a cell-edge area disposed in its periphery. The present embodiment describes the base station device 1 as a base station device configuring an LTE system. The base station devices 1 and 1′ utilize the interstation interface control information (RNTP, HII defined in Non-Patent Document 5) of the LTE system as the information indicating existence/nonexistence of allocation to each mobile station in the cell-edge area with respect to each frequency channel. Since the interstation exchange period of the control information is not defined in Non-Patent Document 5, the period is determined in consideration of a load to an interstation network upon the system design or system operation. An example of the exchange period can be set to several tens of milliseconds.

The base station devices 1 and 1′ employ the dynamic FFR technology. The base station devices 1 and 1′ allocate frequency channels, for use in communications, to mobile stations located in the cells j and j′, wherein they are able to change frequency channels, allocated to standstill mobile stations every moment. Standstill mobile stations are mobile stations whose positions are unchanged in a certain time, i.e. mobile stations that are not moving. In other words, even when mobile stations standing still in the cell j are conducting communication, the base station device 1 is able to change frequency channels allocated to mobile stations with respect to time.

As shown in FIG. 2, the base station device 1 includes a frequency allocation unit (a radio packet scheduler) 10, an information retrieval unit 11, and a radio access control unit 12. The frequency allocation unit 10 further includes an allocable channel specifying part 100, a cell-edge area unallocated channel estimation part 110, a channel allocation part 130, a cell-edge area decision unit 120, and a cell-edge area allocation existence/nonexistence decision part 140. FIG. 2 does not include an illustration in which the adjacent base station device 1′ has the same constitution as the base station device 1 and includes a frequency allocation unit 10′.

The information retrieval unit 11 retrieves information needed for allocation of frequency channels (e.g. system specification, various parameters, radio line quality information). The information retrieval unit 11 supplies the retrieved information to the allocable channel specifying part 100, the cell-edge area decision part 120, and the channel allocation part 130.

The allocable channel specifying part 100 specifies allocable frequency channels (RB) based on the information retrieved by the information retrieval unit 11. Specifically, the allocable channel specifying part 100 calculates a set of allocable frequency channels and supplies the set to the channel allocation part 130.

The frequency allocation unit 10′ of the base station device 1′ disposed in the adjacent cell j′ allocates frequency channels, used for communications, to mobile stations located in the cell-edge area of the cell j′. The cell-edge area unallocated channel estimation unit 110 estimates cell-edge area unallocated channels which differ from frequency channels allocated to mobile stations in the cell-edge area by the frequency allocation unit 10′. Specifically, the cell-edge area unallocated channel estimation unit 110 produces the result of a decision as to whether or not frequency channels are each allocated to mobile stations in the cell-edge area by the frequency allocation unit 10′. Next, the cell-edge area unallocated channel estimation part 110 calculates a cell-edge area allocation likelihood, indicating a likelihood of each frequency channel to be allocated to each mobile station in the cell-edge area of the cell j′, based on the decision result, thus estimating cell-edge area unallocated channels corresponding to frequency channels with a cell-edge area allocation likelihood less than a threshold value. Next, the cell-edge area unallocated channel estimation part 110 supplies the channel allocation part 130 with information indicating the estimated cell-edge area unallocated channels. To further reduce interference, the cell-edge area unallocated channel estimation part 110 may estimate frequency channels, which are not allocated to mobile stations in the cell-central area, in addition to the cell-edge area unallocated channels.

Based on the radio line quality information retrieved by the information retrieval unit 11, the cell-edge area decision part 120 makes a decision as to whether or not mobile stations are each located in the cell-edge area of the cell j. The cell-edge area decision unit 120 supplies the channel allocation part 130 and the cell-edge area allocation existence/nonexistence decision part 140 with the result of a decision as to whether or not mobile stations are each located in the cell-edge area.

The channel allocation part 130 allocates cell-edge area unallocated channels, which are estimated by the cell-edge area unallocated channel estimation part 110, to all the allocation-requesting mobile stations in the cell j. Specifically, the channel allocation part 130 allocates cell-edge area unallocated channels to mobile stations of the cell-edge area prior to mobile stations of the cell-central area in the cell j.

It is possible to imagine the situation in which the channel allocation part 130 fails to allocate cell-edge area unallocated channels to all the allocation-requesting mobile stations in the cell area, i.e. the situation in which not enough cell-edge area unallocated channels remain to transmit all packets to all mobile stations. In this situation, the channel allocation part 130 allocates cell-edge area unallocated channels to allocation-requesting mobile stations in the cell-edge area while allocating frequency channels, except for cell-edge area unallocated channels, to allocation-requesting mobile stations in the cell-central area. A possibility in which cell-edge area unallocated channels can be allocated to all mobile stations is high when a traffic load is low (or when the number of available frequency channels is higher than traffic), whilst the possibility is low when the traffic load is high.

When cell-edge area unallocated channels are allocated to allocation-requesting mobile stations in the cell-edge area while frequency channels, other than cell-edge area unallocated channels, are allocated to allocation-requesting mobile stations in the cell-central area, the channel allocation part 130 allocates residual allocable frequency channels to residual allocation-requesting mobile stations. No special limitation is given in selecting frequency allocating algorithms, but it is possible to use a proportional fairness algorithm.

The channel allocation part 130 supplies the allocation result to the radio access control unit 12 and the cell-edge area allocation existence/nonexistence decision part 140.

The radio access control unit 12 performs access controls and packet transmission/reception processes in radio physical layers based on the allocation result of the channel allocation part 130.

Based on the allocation result of the channel allocation part 130, the cell-edge area allocation existence/nonexistence decision part 140 detects which frequency channel is allocated to each mobile station in the cell-edge area, thus determining existence/nonexistence of allocation per each frequency channel. The cell-edge area allocation existence/nonexistence decision part 140 transmits the decision result to the adjacent frequency allocation device.

Next, concrete examples of operations are explained using variables, having the following meanings, with respect to the cell-edge area unallocated channel estimation unit 110, the cell-edge area decision unit 120, and the cell-edge area allocation existence/nonexistence decision part 140. The following description employs resource blocks (hereinafter, denoted by “RB”) of the LTE system as specific examples of frequency channels.
i: Mobile station ID
j: Current cell (serving cell) ID
j′: Adjacent cell ID adjacent to serving cell j (j′≠j)
J′: Set of adjacent cells j′
N(j): The number of cells adjacent to serving cell j (=|J′|)
k: ID of RB (or ID of resource block group (RBG) consisting of a plurality of RBs)
A: Set of allocable RBs in a system range. Herein, Set A precludes RBs allocated when “persistent allocation” adapted to transmission of a first call of VoIP (Voice over IP) or “retransmission packet allocation” adapted to Hybrid ARQ is given priority.
p(j,k): Bit map information indicating the result of a decision on the existence/nonexistence of allocation of RBk with respect to a mobile station in the cell-edge area of serving cell j. This is notified to an adjacent cell by use of RNTP or HII.
c(j,k): Variable indicating whether or not RBk is allocated to a mobile station in the cell-edge area of an adjacent cell adjacent to serving cell j.
E(j): Set of RBs (cell-edge area unallocated RBs) with a probability (likelihood) of each RB to be allocated to each mobile station in the cell-edge area of an adjacent cell adjacent to serving cell j. A group of cell-edge area unallocated channels (or a group of cell-edge area unallocated RBs).
r(i,j,t): An instantaneous value of RSRP (or RSRQ) in cell j at radio frame t of mobile station i.
R(i,j,t): A long-period average value of RSRP (or RSRQ) in cell j at radio frame t of mobile station i.

R(i,j,t)=E{(r(i,j,t)) (1)

where E{ } is a function for calculating an expected value such as a simple average or an exponential smoothing average.
ΔT: Notification time interval of RNTP or HII.
X₁, X₂, C₁, C₂: Parameters.

[Calculation of p(j,k)]

A procedure for generating bit map information p(j,k) by means of the cell-edge area allocation existence/nonexistence decision part 140 will be described. The cell-edge area allocation existence/nonexistence decision part 140 sets a value “1” representing the existence of allocation to p(j,k) when Prob(k)≧X₁ is satisfied. First, the cell-edge area allocation existence/nonexistence decision part 140 calculates Prob(k) according to Equation (2) when ΔT>Sub-frame length.

Prob(k)=the number of times RBk is allocated to mobile stations in the cell-edge area during ΔT/the total number of RBs allocated in ΔT (2)

In this connection, the cell-edge area allocation existence/nonexistence decision part 140 may adopt an exponential smoothing filter to calculate Prob(k) using a previous value of Prob(k). When the number of times RBk allocated to the mobile stations is sufficiently high, the cell-edge area allocation existence/nonexistence decision part 140 may calculate Prob(k) according to Equation (3).

Prob(k)=the number of times RBk is allocated to mobile stations in the cell-edge area during ΔT/the number of times RBk is allocated to mobile stations during ΔT (3)

Next, the cell-edge area allocation existence/nonexistence decision part 140 calculates p(j,k) according to Equations (4), (5).

p(j,k)=1, if Prob(k)≧X₁ (4)

p(j,k)=0, otherwise (5)

[Calculation of e(j,k)]

The cell-edge area unallocated channel estimation part 110 calculates e(j,k) according to Equation (6).

$$\begin{matrix}[ Expression 1 ] & \\ e ( j , k ) = \frac{{\sum }_{{j}^{′} = 1}^{N ( j )} p ( {j}^{′} , k )}{N ( j )} & ( 6 )\end{matrix}$$

[Calculation of E(j,k)]

The cell-edge area unallocated channel estimation part 110 calculates E(j) according to Equation (7).

E(j)={A [symbol] k|e(j,k)≦X₂} (7)

[Decision (Identification) of Cell-Edge Area]

A procedure for making a decision on the cell-edge area by the cell-edge area decision part 120 will be described. A decision on the cell-edge area is performed using RSRP (Reference Signal Received Power) and RSRQ (Reference Signal Received Quality) prescribed in the 3GPP (see Non-Patent Document 7). The RSRP is an average reception power of cell-inherent reference signals, which is calculated by dividing the sum of reception powers (W) of signal components of cell-inherent reference signals, included in resource elements corresponding to radio resources consisting of combinations of OFDM symbols and OFDM sub-carriers for arranging cell-inherent reference signals, by resource elements used for transmitting cell-inherent reference signals. The RSRQ is a value which is calculated according to Equation (8).

RSRQ=N×RSRP/(E-UTRA carrier RSSI) (8)

In Equation (8), N denotes the number of RBs belonging to a measurement range. The “E-UTEA carrier RSSI” denotes an average value of the sum of reception powers (W) which are observed in the measurement range consisting of N RBs solely with respect to OFDM symbols including reference signals. This average contains interference power and noise power.

The cell-edge area decision part 120 determines a cell-edge area satisfying Equation (9).

$$\begin{matrix}[ Expression 2 ] & \\ \vert R ( i , j , t ) - {max}_{{j}^{′} ∈ {J}^{′}} R ( i , {j}^{′} , t ) \vert \leq {C}_{1} & ( 9 )\end{matrix}$$

The cell-edge area decision part 120 may determine a cell-edge area satisfying Equation (10) instead of Equation (9).

$$\begin{matrix}[ Expression 3 ] & \\ E \{ \vert r ( i , j , t ) - {max}_{{j}^{′} ∈ {J}^{′}} r ( i , {j}^{′} , t ) \vert \} \leq {C}_{1} & ( 10 )\end{matrix}$$

Additionally, the cell-edge area decision part 120 accumulates previous data of r(i,j,t) with respect to all mobile stations in the cell j, and calculates a cumulative probability distribution Pᵣ(j,t) in the cell j involving radio frame t, thus determining a cell-edge area satisfying Equation (11).

Pᵣ(j,t)≦C₂ (11)

The cell-edge area decision part 120 accumulates previous data of R(i,j,t) with respect to all mobile stations in the cell j, and calculates a cumulative probability distribution P_{R}(j,t), thus determining a cell-edge area satisfying Equation (12).

P_{R}(j,t)≦C₂ (12)

As shown in FIG. 2, the cell-edge area decision part 120 discriminates between the cell-central area and the cell-edge area.

Next, a process for allocating RBs in the base station device 1 will be described with reference to FIG. 3. Based on information retrieved by the information retrieval unit 11, the allocable channel specifying part 100 determines allocable RBs (set A), thus supplying allocable RBs (set A) to the channel allocation part 130 (step S100).

The cell-edge area unallocated channel estimation part 110 estimates cell-edge area unallocated RBs (set E(j)) based on a decision result (p(j′,k)), resulting from an allocation existence/nonexistence decision on each RB to be allocated to each mobile station in the cell-edge area, retrieved from the adjacent radio base station 1 (step S110). The cell-edge area unallocated channel estimation part 110 supplies the estimated cell-edge area unallocated RBs (set E(j)) to the channel allocation part 130.

The channel allocation part 130 allocates cell-edge area unallocated RBs (set E(j)) to all the allocation-requesting mobile stations in the cell area (i.e. the cell-edge area and the cell-central area) (step S120). The channel allocation part 130 makes a decision as to whether or not an unallocated RB-allocation-requesting mobile station still remains in the cell area (i.e. the cell-edge area and the cell-central area) (step S130). That is, the channel allocation part 130 makes a decision as to whether or not RBs are successfully allocated to all mobile stations.

This flowchart will be ended when the channel allocation part 130 determines that no unallocated RB-allocation-requesting mobile station remains in the cell area (i.e. the cell-edge area and the cell-central area) (step S130: No), i.e. when the channel allocation part 130 determines that RBs have been successfully allocated to all mobile stations. In this case, RBs with a low probability of being utilized in the cell-edge area of an adjacent cell are allocated to all mobile stations, so that interference with the adjacent cell may hardly occur. In this connection, a low traffic load may increase a probability of cell-edge area unallocated RBs (set E(j)) to be allocated to all mobile stations.

On the other hand, the channel allocation part 130 resets the allocation in step S120 when it determines that unallocated RB-allocation-requesting mobile stations still remain in the cell area (i.e. the cell-edge area and the cell-central area) (step S130: Yes), i.e. when it determines that RBs have not been successfully allocated to all mobile stations. Subsequent to step S140, the channel allocation part 130 allocates cell-edge area unallocated RBs (set E(j)) to allocation-requesting mobile stations in the cell-edge area while allocating RBs other than cell-edge area unallocated RBs (set A-set E(j)) to allocation-requesting mobile stations in the cell-central area (step S150).

Subsequent to step S150, the channel allocation part 130 makes a decision as to whether or not unallocated RB-allocation-requesting mobile stations still remain in the cell area (i.e. the cell-edge area and the cell-central area) (step S160). That is, the channel allocation part 130 allocates cell-edge area unallocated RBs (set E(j)) to all the allocation-requesting mobile stations in the cell-edge area while making a decision as to whether or not RBs other than cell-edge area unallocated RBs (set A-set E(j)) have been successfully allocated to all the allocation-requesting mobile stations in the cell-central area.

This flowchart will be ended when the channel allocation part 130 determines that no unallocated RB-allocation-requesting mobile station remains in the cell area (i.e. the cell-edge area and the cell-central area) (step S160: No), i.e. when the channel allocation part 130 allocates cell-edge area unallocated RBs (set E(j)) to all the allocation-requesting mobile stations in the cell-edge area while determining that RBs other than cell-edge area unallocated RBs (set A-set E(j)) have been successfully allocated to all the allocation-requesting mobile stations in the cell-central area. In this case, RBs with a low probability of being utilized in the cell-edge area of an adjacent cell are allocated to mobile stations in the cell-edge area of the current cell while RBs with a high probability of being utilized in the cell-central area of an adjacent cell are allocated to mobile stations in the cell-central area of the current cell, so that interference with the adjacent cell may hardly occur.

On the other hand, the cell allocation part 130 makes a decision as to whether or not unallocated RBs (i.e. cell-edge area unallocated RBs (set E(j)) or RBs other than cell-edge area unallocated RBs (set A-set E(j)) still remain when it determines that unallocated RB-allocation-requesting mobile stations still remain in the cell area (i.e. the cell-edge area and the cell-central area) (step S160: Yes), i.e. when it determines that an RB among cell-edge area unallocated RBs (set E(j)) cannot be allocated to at least one allocation-requesting mobile station in the cell-edge area or when it determines that an RB among RBs other than cell-edge area unallocated RBs (set A-set E(j)) cannot be allocated to at least one allocation-requesting mobile station in the cell-central area (step S170).

This flowchart will be ended when the channel allocation part 130 determines that no unallocated RB remains (step S170: No). On the other hand, when the channel allocation part 130 determines that unallocated RBs still remain (step S170: Yes), the channel allocation part 130 allocates unallocated RBs to unallocated mobile stations (i.e. allocation-requesting mobile stations of the cell-edge area which are not allocated with cell-edge area unallocated RBs (set E(j)) in step S150, and allocation-requesting mobile stations of the cell-central area which are not allocated with RBs other than cell-edge area unallocated RBs (set A-set E(j))) (step S180). This makes it possible to allocate as many RBs to mobile stations as possible while reducing interference with an adjacent cell. Then, this flowchart will be ended.

According to the present embodiment, it is possible to reduce interference in the dynamic FFR adapted to the real environment.

In the present embodiment, the frequency allocation unit 10 is a constituent part of the base station device 1, but the frequency allocation unit 10 may not serve as a constituent element of a certain device but may serve as an independent device (i.e. the frequency allocation device 10). In this case, as shown in FIG. 2, the frequency allocation device 10 includes the allocable channel specifying part 100, the cell-edge area unallocated channel estimation part 110, the channel allocation part 130, the cell-edge area decision part 120, and the cell-edge area allocation existence/nonexistence decision part 140.

It is possible to store a program implementing the foregoing processing of the frequency allocation part 10 in computer-readable storage media, wherein the program stored in computer-readable storage media is loaded into and executed by a computer system, thus implementing the foregoing processing of the frequency allocation part 10. Herein, the “computer system” may encompass OS and hardware such as peripheral devices. Alternatively, the “computer system” utilizing the WWW system may encompass the homepage providing environment (or display environment). The “computer-readable storage media” refers to flexible disks, magneto-optical disks, ROM, rewritable nonvolatile memory such as flash memory, portable media such as CD-ROM, and storage devices such as hard disks built in a computer system.

With regard to the program transmitted via a network such as the Internet or via communication lines such as telephone lines, the “computer-readable storage media” may encompass any media which are able to retain the program for a certain time, such as volatile memory (e.g. DRAM (Dynamic Random Access Memory)), acting as a server or a client, inside computer system. The program may be transmitted from one computer system whose storage unit stores the program to another computer system via transmission media or by way of transmission waves propagating through transmission media. Herein, the “transmission media” for transmitting the program refers to media with functionality of transmitting information, e.g. networks (communication networks) such as the Internet, and communication lines such as telephone lines. The program may be drafted to implement a part of the foregoing function. Furthermore, the program may refer to a differential file (or a differential program) which is able to implement the foregoing function when combined with another program pre-installed in a computer system.

The embodiment of this invention has been described in detail with reference to the drawings, whereas the concrete constitution is not necessarily limited to this embodiment; hence, this invention may embrace design choices which fall within the scope not departing from the essential matter of this invention.

### INDUSTRIAL APPLICABILITY

The present invention is applicable to an OFDMA system which is able to allocate sub-carriers, which are varied in the time-axis direction within their frequency range, to a plurality of mobile stations (user terminals), wherein it is possible to reduce interference because frequency channels other than frequency channels allocated to the cell-edge area of an adjacent cell are allocated to the cell-edge area of the current cell in the dynamic FFR adapted to the real environment.

### DESCRIPTION OF THE REFERENCE NUMERALS

1 Base station device
10 Frequency allocation unit (Frequency allocation device)
11 Information retrieval unit
12 Radio access control unit
100 Allocable channel specifying part
110 Cell-edge area unallocated channel estimation part
120 Cell-edge area decision part
130 Channel allocation part
140 Cell-edge area allocation existence/nonexistence decision part

1. A frequency allocation device for allocating a frequency channel, used for communication, to a mobile station located in a first cell area of a first cell, comprising:
a cell-edge area unallocated channel estimation part which estimates a cell-edge area unallocated channel corresponding to a frequency channel different from another frequency channel, which an adjacent frequency allocation device installed in a second cell adjacent to the first cell allocates to a mobile station located in a second cell-edge area of the second cell; and
a channel allocation part which allocates the cell-edge area unallocated channel to the mobile station located in the first cell area.

2. The frequency allocation device according to claim 1, wherein the channel allocation part allocates the cell-edge area unallocated channel to a mobile station located in a first cell-edge area of the first cell prior to a mobile station located in a first cell-central area of the first cell.

3. The frequency allocation device according to claim 1, wherein the channel allocation part allocates the cell-edge area unallocated channel to an allocation-requesting mobile station located in a first cell-edge area when the cell-edge area unallocated channel cannot be allocated to each of all the allocation-requesting mobile stations located in the first cell area.

4. The frequency allocation device according to claim 3, wherein the channel allocation part allocates a residual allocable frequency channel to a residual allocation-requesting mobile station when the cell-edge area unallocated channel is allocated to an allocation-requesting mobile station located in the first cell-edge area while a frequency channel different from the cell-edge area unallocated channel is allocated to an allocation-requesting mobile station located in the first cell-central area.

5. The frequency allocation device according claim 1, wherein the cell-edge area unallocated channel estimation parts receives a decision result of a decision per each frequency channel as to whether or not the adjacent frequency allocation device allocates each frequency channel to a mobile station located in the second cell-edge area, and calculates a cell-edge area allocation likelihood representing a likelihood of each frequency channel to be allocated to the mobile station located in the first cell-edge area based on the decision result, thus estimating the cell-edge area unallocated channel corresponding to a frequency channel with the cell-edge area allocation likelihood less than a threshold value.

6. The frequency allocation device according to claim 5 further comprising a cell-edge area allocation existence/nonexistence decision part which makes a decision on existence/nonexistence of each frequency channel to be allocated to the mobile station located in the first cell-edge area based on the allocation result of the channel allocation part, wherein the cell-edge area allocation existence/nonexistence decision part transmits its decision result to the adjacent frequency allocation device.

7. A frequency allocation device for changing a frequency channel allocated to a mobile station standing still in a cell area of a first cell with respect to time, said frequency allocation device allocating a frequency channel, estimated to be different from a frequency channel which another frequency allocation device installed in a second cell adjacent to the first cell allocates to a mobile station located in a cell-edge area of the second cell, to a mobile station located in a cell-edge area of the first cell prior to a mobile station located in a cell-central area of the first cell.

8. A program causing a computer of a frequency allocation device for allocating a frequency channel, used for communication, to a mobile station located in a first cell area of a first cell, to implement:
a cell-edge area unallocated channel estimation step for estimating a cell-edge area unallocated channel corresponding to a frequency channel different from a frequency channel which an adjacent frequency allocation device installed in a second cell adjacent to the first cell allocates to a mobile station located in a second cell-edge area of the second cell; and
a channel allocation step for allocating the cell-edge area unallocated channel to the mobile station located in the first cell area.
